(19) United States
(12) Patent Application Publication
(10) Pub. No.: US 2023/0123172 A1
(43) Pub. Date: Apr. 20, 2023

(54) System and Method for Removing Plumbing Fixture Buildup

(71) Applicant: Eric Stephen Pavlack, Indianapolis, IN (US)

(72) Inventor: Eric Stephen Pavlack, Indianapolis, IN (US)

(21) Appl. No.: 17/968,954

(22) Filed: Oct. 19, 2022

Related U.S. Application Data
(60) Provisional application No. 63/257,350, filed on Oct. 19, 2021.

(51) Int. Cl. C11D 17/04; B05B 15/55; B05B 15/52; B08B 3/08; C11D 11/00; C11D 17/06

(52) U.S. Cl. CPC C11D 17/043; B05B 15/55; B05B 15/52; B08B 3/08; C11D 11/0023; C11D 17/06

(57) ABSTRACT

Buildup in a plumbing fixture is removed by providing a bag containing a quantity of concentrated fixture cleaning chemicals and then securing the bag to the fixture to be cleaned. After securing the bag to the fixture, the bag is filled with water from the fixture which mixes with the concentrated chemicals to create a cleaning solution that covers the fixture, and then the fixture is allowed to soak in the created cleaning solution to thereby dissolve the buildup.

### CROSS-REFERENCE TO RELATED APPLICATIONS

This application claims the benefit of provisional application 63/257,350 filed Oct. 19, 2021, the disclosure of which is hereby incorporated by reference.

### FEDERALLY SPONSORED RESEARCH OR DEVELOPMENT

None.

### TECHNICAL FIELD

The present invention relates to cleaning implements and methods, specifically those that are used to clean showerheads, faucets, and similar plumbing fixtures.

### BACKGROUND

Showerheads, faucets, and similar plumbing fixtures routinely accumulate deposits of lime and other minerals, and other foreign materials, which impede proper water flow, can be unsightly, and are difficult to clean. While commercially available chemical solutions such as CLR® and LIME-A-WAY® effectively dissolve mineral and other deposits, they generally require the mineral and other deposits to be soaked in the solution for several minutes, or more. Administering those chemical solutions to the plumbing fixture, which tend to face downward and, in the case of showerheads are positioned overhead, can be difficult, absent removal and/or disassembly of the plumbing fixture before soaking.

A makeshift method is to fill a plastic bag with a diluted chemical solution, position it over the fixture, and then attempt to secure the bag and chemical solution to the fixture so as to submerge the affected areas. However, this method is difficult and often ineffective, as it is challenging to position the bag filled with chemical solution in such a way that the mineral and other deposits are completely submerged for the required duration of time. It is also potentially dangerous, as it requires the user to work overhead with a bag full of potentially caustic liquid chemicals. An example of this method is shown in U.S. Pat. No. 9,351,560 to Tussy, which is hereby incorporated by reference.

### SUMMARY

The present invention provides novel systems and techniques for cleaning showerheads, faucets, and similar plumbing fixtures. While the actual nature of the invention covered herein can only be determined with reference to the claims appended hereto, certain aspects of the invention that are characteristic of the embodiments disclosed herein are described briefly was follows.

In one form, the present invention provides a method for cleaning a plumbing fixture in which a bag containing a chemical concentrate is first attached to the fixture, and then the attached bag is filled with water from the fixture to form the fixture cleaning chemical solution. In a preferred form, the bag is secured to the fixture in an airtight fashion, such as via straps or tape, and the bag includes a degassing valve that allows air to escape as the attached bag is filled with water from the fixture. The chemical concentrate can be initially provided in the bag in solid form, such as a powder or crystal. Alternatively, the chemical concentrate can be initially provided in the bag as a concentrated liquid or gel, for example provided in a dissolvable pouch or frangible vial. In either case, the amount of chemical concentrate in the bag when it is initially attached to the fixture is relatively small and light, which facilitates handling. Then, after the bag is attached to the fixture, the chemical concentrate is mixed with substantial water from the faucet, such as at least 5-10 times by volume and/or weight, to form the fixture cleaning chemical solution. The fixture is then left immersed in this formed cleaning solution for a period of time to allow the accumulated mineral and other deposits to be dissolved. Then, the bag may be punctured to allow the solution to drain, and the bag removed.

In another form, the present invention provides a plastic bag featuring an air release valve that allows a bag containing a relatively small volume of a chemical concentrate to be placed over a plumbing fixture. The bag is secured around the stem of the fixture using straps, elastic tape or a Velcro strap to create an air-tight seal. Once sealed in place, a valve controlling water flow to the fixture is carefully turned on to deposit water into the secured-in-place bag, just long enough to fill it. As the bag fills, water is displaced and escapes through the air release valve, which may be a one-way degassing valve, that is positioned above the desired water line. The affected areas of the fixture then become completely submerged. The chemical concentrate dissolves, forming a chemical solution that remains in contact with the mineral or other deposits in the fixture for as long as the user desires. Once the mineral and other deposits of the fixture have been sufficiently dissolved, the user simply cuts a hole in the bottom of the bag to drain it and removes the now empty bag.

Additional aspects, alternatives and variations as would be apparent to persons of skill in the art are also disclosed herein and are specifically contemplated as included as part of the invention.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying figures forming a part thereof, in which:

FIG. 1 shows a side view of a cleaning bag about to be placed over a fixture according to an embodiment;

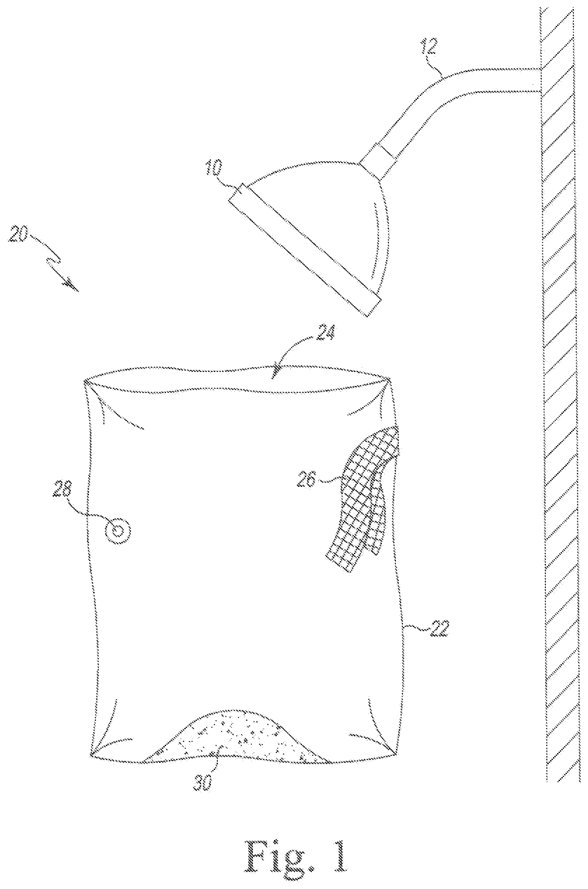

FIG. 2 shows the cleaning bag of FIG. 1 secured over the fixture; and

FIG. 3 shows the fixture soaking in the cleaning bag after the cleaning bag has been filled with water.

### DETAILED DESCRIPTION OF EXAMPLE EMBODIMENTS

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the appended claims.

Turning now to the Figures, cleaning system 20 comprises a plastic bag 22 having an open top 24, a pair of Velcro straps 26, and an air release valve 28 incorporated into the sidewall of the bag. Bag 22 also contains a fixture cleaning chemical concentrate 30, which as illustrated is in the form of crystals or powder. The chemical concentrate 30 could also be a concentrated liquid or gel, for example provided in a dissolvable pouch or frangible vial.

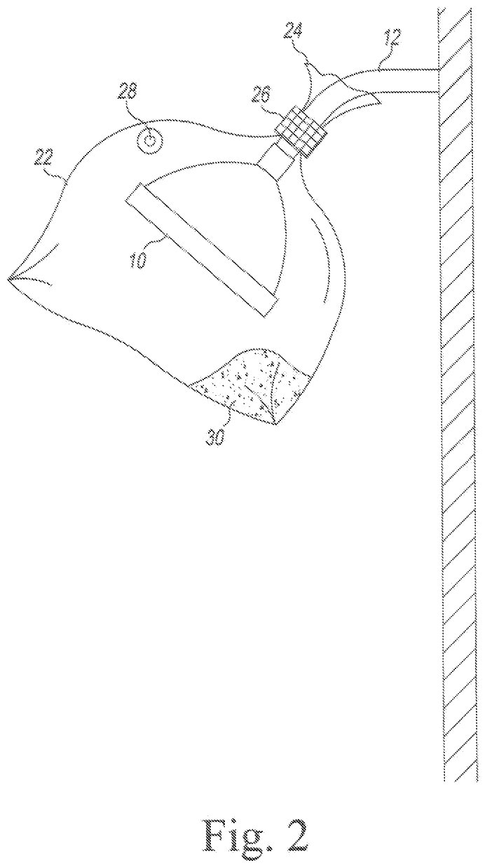

During use, the open top 24 of the bag 22 is placed over a fixture 10 and secured to the stem 12 with the straps 26, as shown in FIG. 2. Other means for securing the bag 22 to the fixture 10 could be used, such as tape, elastic tape, an elastic band, or a single Velcro strap. As illustrated, the straps 26 are provided attached to the bag near its open top 24. Alternatively, the straps 26, or other securing means may be provided separate from the bag, which can provide the user greater flexibility in attaching the bag over different types of fixtures. The valve 28 is located in the bag just below the straps 12 and above the fixture 10. Then, with the bag 22 secured in place over the fixture 10, the faucet is turned on to introduce water into the bag.

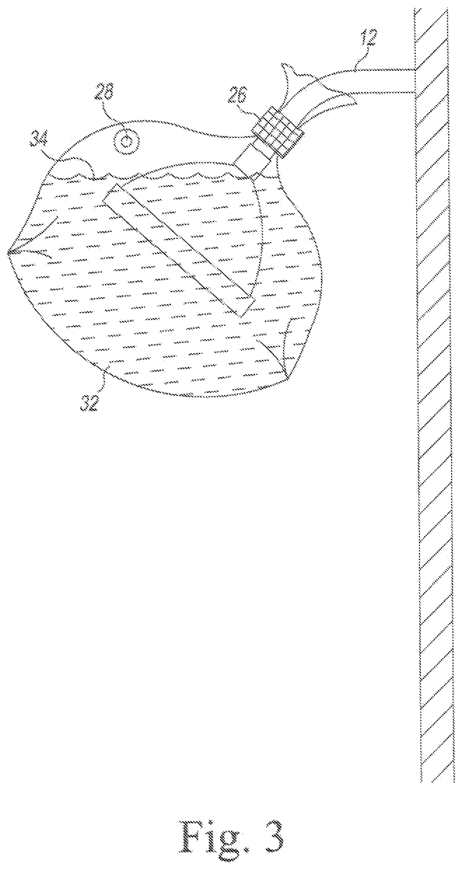

As the water is introduced, displaced air is degassed through the valve 28, as needed. With reference to FIG. 3, the introduced water mixes with the chemical concentrate 30 to form a fixture cleaning chemical solution 32. The water is introduced until the level 34 of the solution 32 covers the fixture 10. The fixture 10 is then allowed to soak in the cleaning solution. Upon completion, the bag can be punctured, such as with scissors or a knife, so as to allow the cleaning solution to drain, and the cleaning bag removed.

It is to be appreciated that the fixture cleaning chemical concentrate 30 can be any suitable chemical, or mixture of chemicals, that, when mixed with water from the faucet, forms a solution suitable to dissolve the mineral and other depositions that typically clog plumbing fixtures, such as showerheads, faucets and the like. In one form, the cleaning concentrate 30 includes powdered sulfuric acid or sulfonic acid crystals. In another form, the concentrate 30 is concentrated liquid or gel provided in a frangible vial or dissolvable packet, similar to a laundry detergent dissolvable packet such as a Tide® Pod. When a frangible vial us employed, the user would break the vial to release the concentrate after affixing the bag to the fixture, or the vial itself could be water-soluble and dissolve upon introduction of water from the faucet.

It is also to be appreciated that the quantity of fixture cleaning chemical concentrate 30 initially provided in the bag is small and light, which facilities handling and attachment of the bag 22 to the fixture 10. Accordingly, when forming the fixture cleaning chemical solution 32, the quantity of water added to the bag after being attached to the fixture is at least about 5-10 times the quantity of the cleaning concentrate. Similarly, the volume of the fixture cleaning chemical concentrate 30 provided in the bag will be much less than the maximum volume of the bag 22 itself, for example being less than about 10% of the maximum volume of the bag, such as less than about 5%. For example, if the bag 22 is the size of a conventional one gallon food storage bag, the volume of the fixture cleaning chemical concentrate 30 provided in the bag would be less than about 12.8 fluid ounces (10% of 1 gallon), or less than about 6.4 fluid ounces (5% of 1 gallon).

Prior to use, the top 24 of the bag may be kept closed, so as to keep the contents of the bag (i.e. the chemical concentrate 30) secure prior to use. The included straps 26 may be used for this purpose. Alternatively, the top of the bag can be closed by a separate closure means, such as by a conventional zip type closure mechanism (not shown), such as are conventionally provided on plastic food storage bags, such as ZIP LOCK® freezer bags.

It is also to be appreciated that the function of the air release valve 28 is to allow entrapped air to escape the bag as it is being filled with water, thereby avoiding any excess pressure buildup that might otherwise cause the bag to burst as it is being filled with water. It is also desirable that the valve 28 not allow the concentrated chemicals to escape prior to use, for example during transport, storage, and handling of the bag prior to use. Accordingly, the valve 28 may be any suitable degassing mechanism incorporated into the sidewall of the bag that accomplishes these purposes, such as a conventional check valve or blowout valve that selectively opens so as to provide for the release of air when the air pressure in the bag exceeds the air pressure outside the bag. Alternatively, given the one-time use nature of the bag, the valve 28 may be formed by a small hole in the bag that is releasably covered by a flap, wherein the flap is initially held in place over the exterior of the hole via a mild adhesive that releases to uncover the hole under a modest pressure buildup inside the bag. Alternatively, air may be released by forming an air release opening in the bag after securing the bag to the fixture, such as by cutting or puncturing the bag with a pair of scissors.

Any of the suitable technologies set forth and incorporated herein may be used to implement various example aspects of the invention as would be apparent to one of skill in the art. Although exemplary embodiments and applications of the invention have been described herein including as described above and shown in the included example Figures, there is no intention that the invention be limited to these exemplary embodiments and applications or to the manner in which the exemplary embodiments and applications operate or are described herein. Indeed, many variations and modifications to the exemplary embodiments are possible as would be apparent to a person of ordinary skill in the art. The invention may include any device, structure, method, or functionality, as long as the resulting device, system or method falls within the scope of one of the claims that are allowed by the patent office based on this or any related patent application.

What is claimed is:

1. A method for removing buildup in a plumbing fixture, comprising:
providing a bag containing a quantity of concentrated fixture cleaning chemicals;
securing the bag to the fixture to be cleaned;
after securing the bag to the fixture, filling the bag with water from the fixture so as to create a cleaning solution that covers the fixture; and then
allowing the fixture to soak in the created cleaning solution to thereby dissolve the buildup.

2. The method of claim 1 further comprising, while filling the bag with water from the fixture, allowing air to escape the bag via an air release valve provided in a sidewall of the bag or via a hole formed in the bag after the bag has been secured to the fixture.

3. The method of claim 1 wherein substantially all of the water in the cleaning solution comes from the fixture after the bag has been secured to the fixture.

4. The method of claim 1 wherein a majority of the water in the cleaning solution comes from the fixture after the bag has been secured to the fixture.

5. The method of claim 1 wherein the fixture cleaning chemicals are provided in the bag in a non-liquid form.

6. The method of claim 5 wherein the fixture cleaning chemicals are provided in powder or crystal form.

7. The method of claim 1 wherein the fixture cleaning chemicals are provided as a concentrated liquid in a dissolvable or breakable container.

8. The method of claim 7 wherein the fixture cleaning chemicals are provided in a gel pack or a frangible vial.

9. The method of claim 1 wherein the bag is secured to the fixture in a substantially airtight fashion.

10. The method of claim 1 wherein the bag is secured to the fixture via straps or tape.

11. The method of claim 1 further comprising cutting a hole in the bag to drain the cleaning solution after the fixture has soaked in the cleaning solution.

12. A system for cleaning a plumbing fixture, comprising:
a plastic bag having an open top and an air release valve formed in a sidewall of the bag;
a small volume of concentrated fixture cleaning chemicals in the bag, wherein the volume of the concentrated fixture cleaning chemicals is less than about 10% of the maximum capacity of the bag; and
means for securing the open top of the bag to a plumbing fixture in a substantially airtight fashion, wherein the secured bag may be thereafter be filled with water from the fixture to form a fixture cleaning solution sufficient to dissolve buildup in the fixture.

13. The system of claim 12 wherein the means for securing comprises straps or tape.

14. The system of claim 12 wherein the concentrated fixture cleaning chemicals are provided in the bag in a non-liquid form

15. The system of claim 14 wherein the concentrated fixture cleaning chemicals are provided in powder or crystal form.

16. The system of claim 12 wherein the concentrated fixture cleaning chemicals are provided as a concentrated liquid of gel in a dissolvable or breakable container.
